(19) United States
(12) Patent Application Publication
(10) Pub. No.: US 2004/0076727 A1
(43) Pub. Date: Apr. 22, 2004

(54) Method and system for molding ice cream novelties and cakes

(76) Inventor: Russ L'Hommedieu, Cutchogue, NY (US)

Correspondence Address: Mitchell A. Stein, Esq., STEIN LAW, P.C., Suite 4, 24 Woodbine Avenue, Northport, NY, 11768, US

(21) Appl. No.: 10/278,196

(22) Filed: Oct. 22, 2002

(51) Int. Cl. A23P 1/00

(52) U.S. Cl. 426/515

(57) ABSTRACT

A method and system for making ice cream novelties and cakes is shown, including selecting a mold comprised of a flexible, elastomeric, silicone-based material (preferably a combination of GE 6035 and GE 6075), obtaining ice cream in a temperature range between 0°F. to 20°F., folding the ice cream into the selected mold to create a molded material, adding layers or filling if desired, allowing the molded material to harden at a time and temperature sufficient to permit minimal to optimal hardness for demolding without sacrifice of integrity of the molded material, and demolding the molded material from the mold. The mold combination is 25% and 75% of GE 6035 and GE 6075, respectively. Where the selected mold is an ice cream pop mold of a size 8 cm by 4.7 cm by 2.5 cm, the minimal unmolding occurs at −10° F. at 52 minutes and optimal unmolding occurs at −14° F. at one hour. Where the selected mold is a deep small cake mold 20 cm round by 4.5 cm deep, the minimal unmolding occurs at 0° F. at one hour and twenty-two minutes and optimal unmolding occurs at −5° F. at one hour and forty five minutes. Where the selected mold is a deep large cake mold 24 cm round by 5.7 cm deep, the minimal unmolding occurs at 0° F. at two hours and twenty two minutes and optimal unmolding occurs at −5° F. at two hours and forty five minutes.

### FIELD OF THE INVENTION

The present invention relates to the field of ice cream making, and more particularly to the field of ice cream novelties and cakes, employing molds, and more particularly to making such novelties and cakes through the use of flexible molds thereby allowing easier removal of such novelties and cakes from molds under controlled temperature conditions while preserving the physical properties and appearance of the completed novelty and cake.

### BACKGROUND OF THE INVENTION

Ice cream and related desserts are perhaps the largest selling desserts in the world, with the United States leading production, and China the next in line. The Latest Scoop, 2000 Edition, International Dairy Foods Association. Interestingly, New Zealand leads the world in consumption, with the United States, second. Id. Generally, ice cream is comprised of milk fat, non-fat milk solids, sucrose, corn syrup solids, stabilizers, emulsifiers, and water, in which water comprises between, on average 55% to 64% of the mix by weight. The quality of ice cream increases in proportion to the amount of solids and milk fat content, with the super-premium brands having the greater percentage of this content, in comparison to the economy brands.

As a result of the commercial need to satisfy the dessert hungry, ice cream is sold in a plurality of ways, from grocery store to ice cream store. Indeed, some even seek to make their own ice cream at home. Ice cream also comes in a variety of different manners and shapes, from typical scooped preparations, to cones, sundaes, novelties and cakes.

Ice cream that is shaped into novelties and cakes is typically first made, and then applied to a mold. If the ice cream is already tempered in the process of folding the ice cream into a mold, it need not be tempered again. Tempering involves allowing the ice cream, after admixture of ingredients, to freeze quickly to a temperature below about 0° F.

Typical molds for ice cream are comprised of stiff materials, and it hence difficult to remove the molded ice cream novelty or cake from the mold. In the process of removal, the finished novelties or cake may fracture, portions may be broken off or incompletely formed, and the visual appearance and characteristics of the finished piece are not always consistent. The situation is most problematic where temperature cannot be well controlled in, for example, the home kitchen or ice cream store.

Hence, there is a need in the industry for a method and system for making ice cream novelties and cakes where ice cream can be folded into molds, and easily removed, with consistency maintained in the final product.

Flexible molds exist, but are typically relegated to baking. For example, silicone molds for baking are shown in U.S. Pat. No. 6,197,359 to Hompanera. No mention is made of the use of such molds for ice cream novelties or ice cream cakes, nor of any of the necessary and critical parameters to be employed if such molds are to be utilized for the same. Indeed, it is heretofore unknown to use any form of flexible molds in the making of ice cream novelties and ice cream cakes.

It is therefore an object of the instant invention to provide a method and system for making ice cream novelties and cakes through the use of molds, where the molds are flexible and the product can be easily removed with full maintenance of the integrity of the final product, and under simple temperature conditions that minimize the degradation of the ice cream.

### SUMMARY OF THE INVENTION

The various features of novelty which characterize the invention are pointed out with particularity in the claims annexed to and forming a part of the disclosure. For a better understanding of the invention, its operating advantages, and specific objects attained by its use, reference should be had to the drawings and descriptive matter in which there are illustrated and described preferred embodiments of the invention.

The foregoing objects and other objects of the invention are achieved through a method and system for making ice cream novelties and cakes which uses a mold comprised of a flexible, elastomeric, silicone-based material. Such material, heretofore unknown in the molding of ice cream, provides easy demoldability, while preserving the integrity of the final product. Preferably, a combination of GE 6035 and GE 6075, is used, and in the currently preferred embodiment, the combination is 25% and 75% of each, resepctively.

Ice cream is maintained in a temperature range between 0° F. to 20° F., when placed in the mold. The ice cream is folded into the selected mold to create a molded material. Layers or filling are added if desired, and the firmness of the combination of the first layer and ice cream is maintained by lowering the temperature to 10° F. to −10° F. Thereafter, an additional layer or filling is added if desired.

Once the aggregate is complete, it is allowed to harden at a time and temperature sufficient to permit minimal to optimal hardness for demolding without sacrifice of integrity of the molded material, and demolding the molded material from the mold. Where the selected mold is an ice cream pop mold of a size 8 cm by 4.7 cm by 2.5 cm, the minimal unmolding occurs at −10° F. at 52 minutes and optimal unmolding occurs at −14° F. at one hour. Where the selected mold is a deep small cake mold 20 cm round by 4.5 cm deep, the minimal unmolding occurs at 0° F. at one hour and twenty-two minutes and optimal unmolding occurs at −5° F. at one hour and forty five minutes. Where the selected mold is a deep large cake mold 24 cm round by 5.7 cm deep, the minimal unmolding occurs at 0° F. at two hours and twenty two minutes and optimal unmolding occurs at −5° F. at two hours and forty five minutes.

Other features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims.

### BRIEF DESCRIPTION OF THE DRAWINGS

In the drawings, wherein similar reference characters denote similar elements through the several views:

FIG. 1 is a flow chart of the processing steps of the method and system in accordance with a preferred embodiment of the subject invention;

FIG. 2(a) is a planar view of the rear of a flexible pop mold, to be used in accordance with the preferred embodiment of the subject invention;

FIG. 2(b) is a planar view of the bottom edge of the flexible pop mold shown in FIG. 2(a), to be used in accordance with the preferred embodiment of the subject invention;

FIG. 2(c) is a planar view of a side edge of the flexible pop mold shown in FIGS. 2(a) and 2(b), to be used in accordance with the preferred embodiment of the subject invention;

FIG. 3(a) is a planar view of the top of a flexible round mold, to be used in accordance with the preferred embodiment of the subject invention;

FIG. 3(b) is a cross-sectional view of the flexible round mold as shown in FIG. 3(a), taken along line B-B thereof, to be used in accordance with the preferred embodiment of the subject invention;

FIG. 4 is a transparent three-dimensional rendering of the flexible round mold as shown in FIGS. 3(a) and 3(b), to be used in accordance with the preferred embodiment of the subject invention;

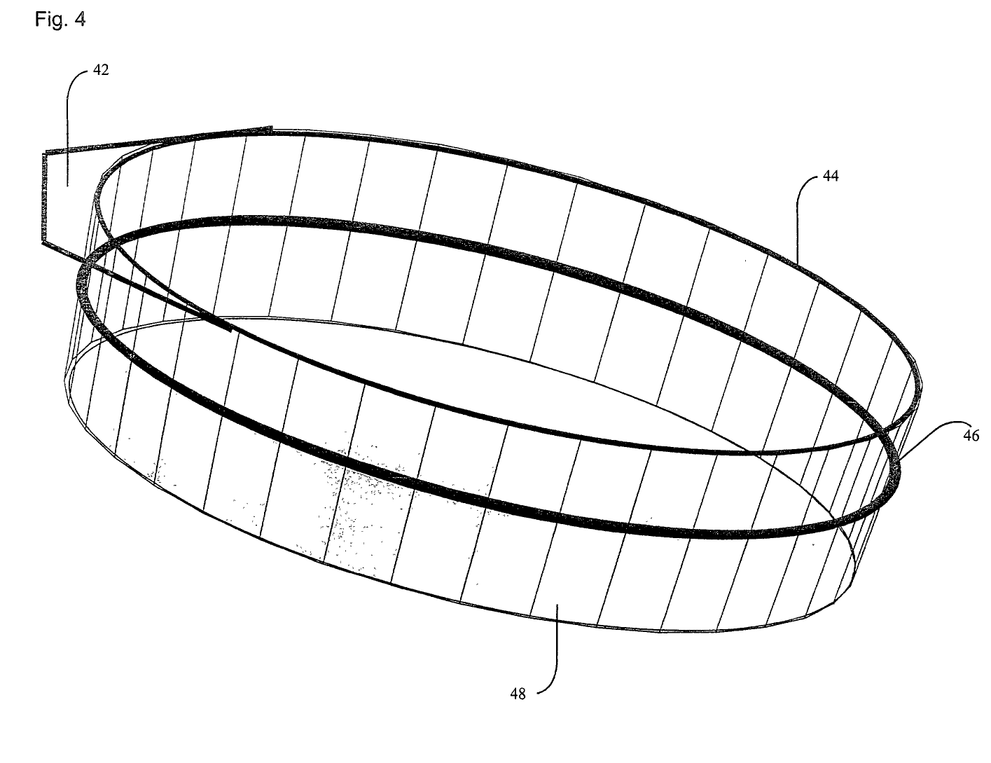

FIG. 5(a) is a planar view of the top of a flexible truffle mold, to be used in accordance with the preferred embodiment of the subject invention;

FIG. 5(b) is a perspective view of the side of the flexible truffle mold shown in FIG. 5(a), to be used in accordance with the preferred embodiment of the subject invention;

FIG. 5(c) is a top view and side view of an ice cream truffle, made with the mold shown in FIGS. 5(a) and 5(b) and in accordance with the preferred embodiment of the subject invention;

FIG. 6 is a transparent three-dimensional rendering of a flexible rectangular mold, to be used in accordance with the preferred embodiment of the subject invention;

FIG. 7 is a graphical representation of the freezing curve of ice cream that is pop-styled and made in accordance with the preferred embodiment of the subject invention, employing the flexible pop mold shown in FIGS. 2(a), 2(b) and 2(c);

FIG. 8 is a graphical representation of the freezing curve of ice cream that is round-styled and made in accordance with the preferred embodiment of the subject invention in a deep, small round mold with a configuration like that shown in FIGS. 3(a), 3(b) and 4;

FIG. 9 is a graphical representation of the freezing curve of ice cream that is round-styled and made in accordance with the preferred embodiment of the subject invention in a deep large mold with a configuration like that shown in FIGS. 3(a), 3(b) and 4; and

FIG. 10 is a freeze curve comparison of the freezing curves of ice cream shown in FIGS. 7, 8 and 9.

### DETAILED DESCRIPTION OF THE PREFERRED EMBODIMENTS

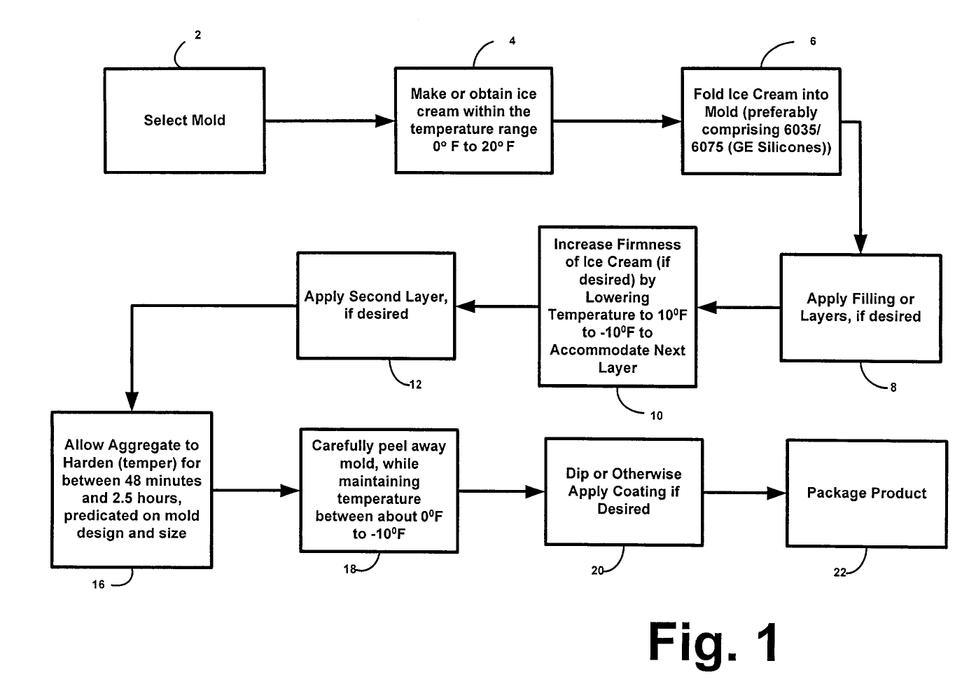

In accordance with the subject invention, FIG. 1 shows a preferred method for making ice cream novelties and cakes in accordance with the subject invention, in which in step 2, a mold is selected. In particular, step 2 mold selection permits the selection of a mold from a plurality of options including, by way of example, a cake mold (whether a deep or a shallow, whether in large diameter or small (e.g., a 20 cm round, 4.5 cm deep or a 24 cm round, 5.7 cm deep), or a truffle-styled novelty, pop-styled novelty, or a sheet cake style. It should be appreciated that one of ordinary skill in the art can determine a multiplicity of molds that will function herein without deviation from the spirit, intent or claim scope of the subject invention.

After selecting the mold in step 2, the next step 4 is to make or obtain ice cream that is within the temperature range of 0° F. to 20° F. This critical temperature range permits the obtainment of ice cream that preserves the overall integrity of the ice cream in structure, flavor, crystallization and the like. After selecting the ice cream to be employed in step 4, the selected ice cream is then folded into the mold (selected in step 2) at step 6. In particular, and of import to the subject invention, the mold selected is flexible. Flexibility is achieved through the use herein of a preferred mold material of a silicone elastomer, in particular GE silicones comprising 6035 and 6075. These silicones are general purpose Silplus stocks which have durometers of 35 and 70 respectively, designed to accept moderate to high levels of reinforcing or extending fillers and additives for property variation. Blending provides durometers between 35 and 70. The currently preferred embodiment of the subject invention employs 6035 at 25% and 6075 at 75%.

It has been discovered herein that the use of the aforementioned silicone elastomer combination provides a mold that is flexible and withstands the temperature fluctuations employed herein while still maintaining structural support, and permits, at the time and temperature parameters involved, the creation of the ice cream novelty and/or cake and its easy removeability (or demolding) to enable the removal of the completed product without sacrifice of the product shape or quality.

After the ice cream is folded into the mold at step 6, if filling or layers are desired, then the same is applied at step 8. Thereafter, at step 10, the firmness of the ice cream is increased, if desired, by lowering the temperature to 10° F. to −10° F. to accommodate the next layer. The next layer is applied at step 12.

Application of layers or fillings, as the names imply, are the folding in of layers or fillings of different materials including, by way of example, syrups, jellies, fruit compotes, sorbet, candy, baked confectionary and the like. The material can be layered or filled in any manner known to one of ordinary skill in the art.

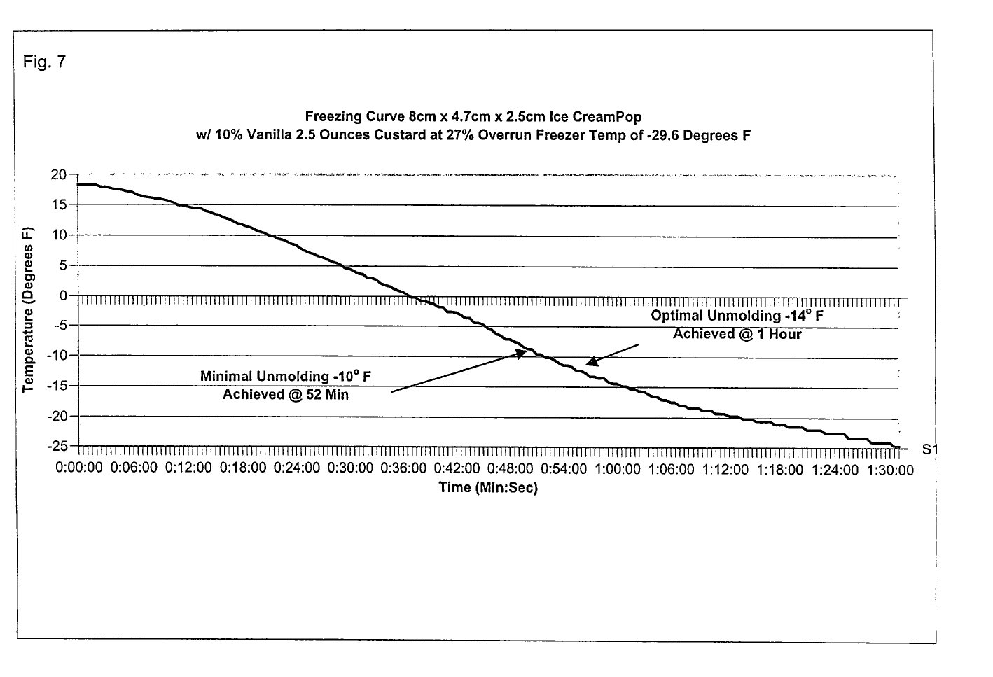

The second layering or filling, if desired, occurs at step 12. Thereafter, the aggregate is allowed to harden (or temper) at step 16 for between 48 minutes and 2.5 hours predicated on mold design and size (assuming an average blast freezer temperature of between −25° F. and −30° F. and a starting temperature of the aggregate at between 10° F. and 20° F.). In particular, it has been determined that these time and temperature parameters are necessary for easy release of the product from the mold, as shown and explained in greater detail with reference to FIGS. 7 to 10, below.

After the aggregate is permitted to harden at step 16, the product is demolded by carefully peeling it away from the mold at step 18. In this step the temperature is maintained between about 0° F. to −14° F. After the product is removed from the mold at step 18, if a coating or dip is required (including, e.g., chocolate, flavor, or the like), the same is applied at step 20. Thereafter the product is packaged (if for commercial sale) at step 22, by applying, for example, a heatedly sealed plastic wrapper with a label. At this point the novelty or cake is complete.

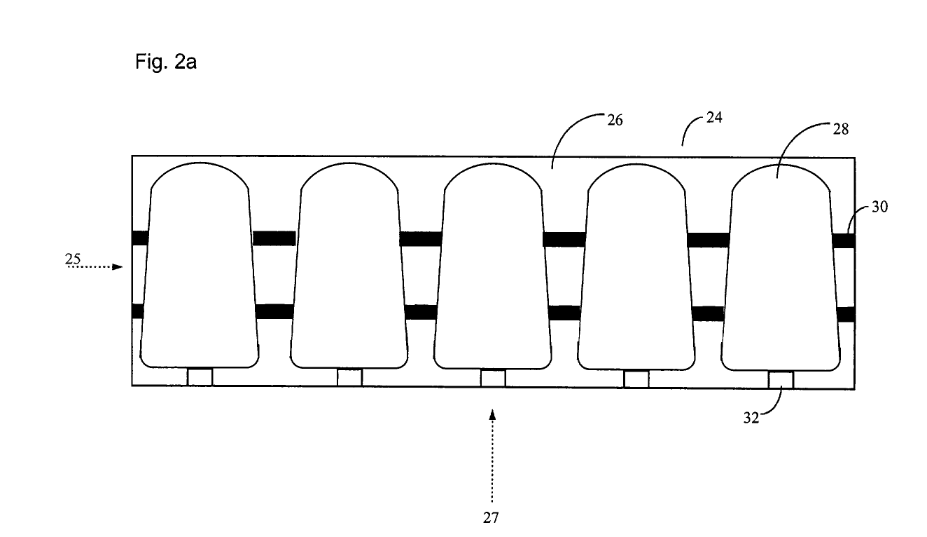

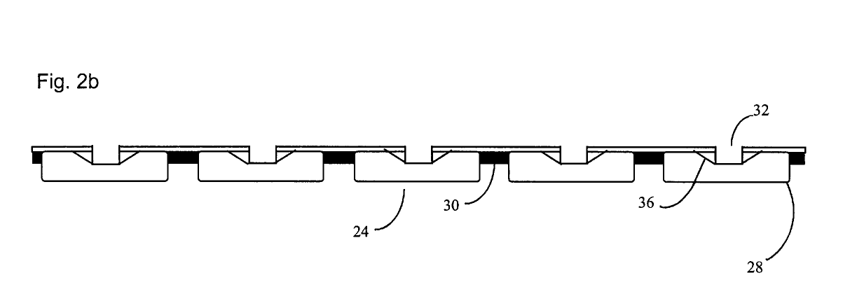

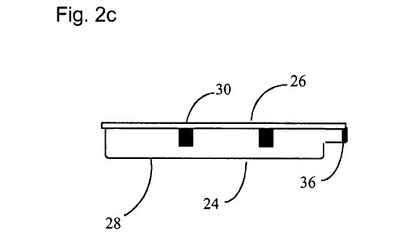

FIG. 2(a) shows a planar perspective of a pop-styled mold 24 for making, in this case, five pops. Pops, by definition, have a stick on which the ice cream (or aggregate combination) resides. The stick is used as a handle while the ice cream is consumed. In this instance, the mold permits the stick to be laid in the mold, such that a stick relief 32 is provided. Struts 30 reinforce the flexible mold material, thereby permitting maintenance of the integrity of the mold, while it is flexed during demolding and while the material is being applied prior to aggregation. Pop cavities 28 (five in these instances) are provided for receiving the ice cream and aggregates. Deck 26 provides the overall shape of the mold, as shown in FIG. 2(a).

FIG. 2(b) shows the side of the flexible mold assembly 24 at view 27 (as shown in FIG. 2(a)). In particular, shown are the cavities 28, stick reliefs 32, reinforcing struts 30, and stick relief reinforcing struts 36 for mold 24.

FIG. 2(c) shows the side of the flexible mold assembly 24 at view 25 (as shown in FIG. 2(a)). In particular, shown is a pop cavity 28, a reinforcing strut 30, deck 26, and a stick relief reinforcing strut 36.

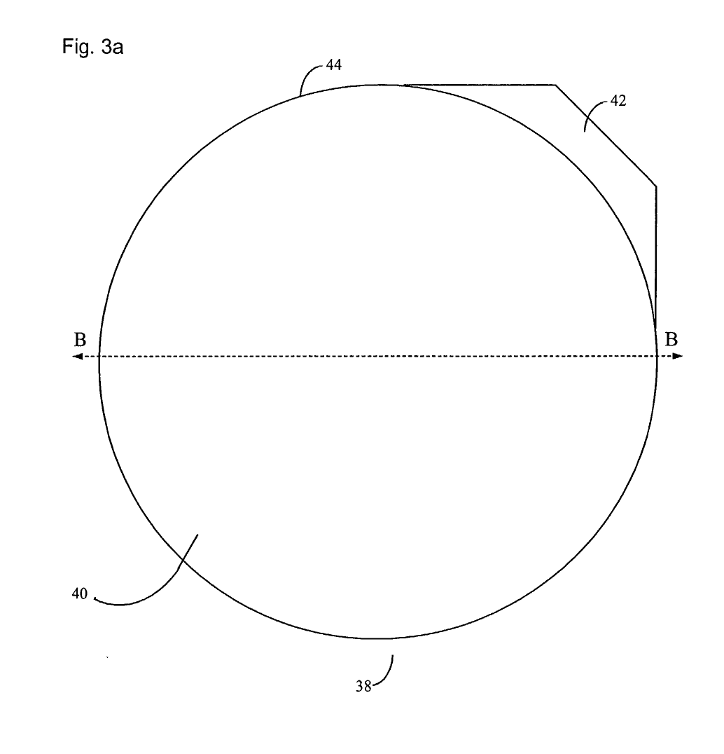

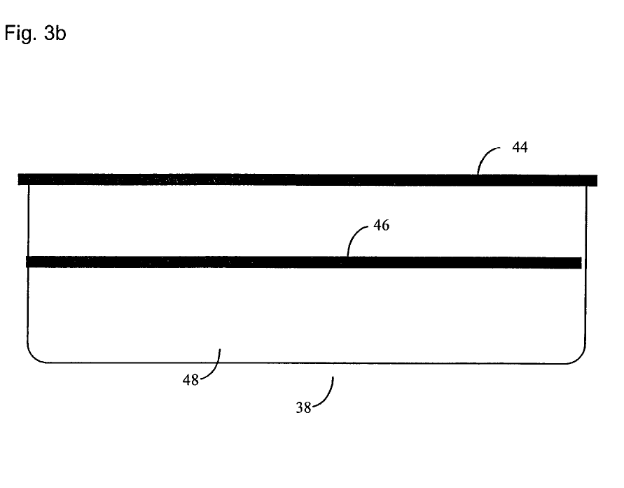

FIG. 3(a) shows a planar view of a cake mold assembly 38. Shown is a cavity 40 for the ice cream and aggregate material, edge 44, and pull tab 42. In operation, after the aggregate is formed, pull tab 42 is employed for facilitating the demolding of the product from the mold 38.

FIG. 3(b) shows a cross-section of the cake mold assembly 38, as shown in FIG. 3(a), along line B-B. In particular, now visible are the edge 44, cavity 48, and ridge 46 for delineating half of the depth of the mold 38. In this manner, layers can be accurately provided, in that the ice cream is folded below the ridge, the layer is thereupon provided to cover the ridge, and the next layer is added thereabove. Proportionate layers separated by the layer result from use of this assembly 38.

FIG. 3(c) shows a transparent three-dimensional view of the cake mold assembly 38, in which like terms have like meanings as those shown in FIGS. 3(a) and 3(b).

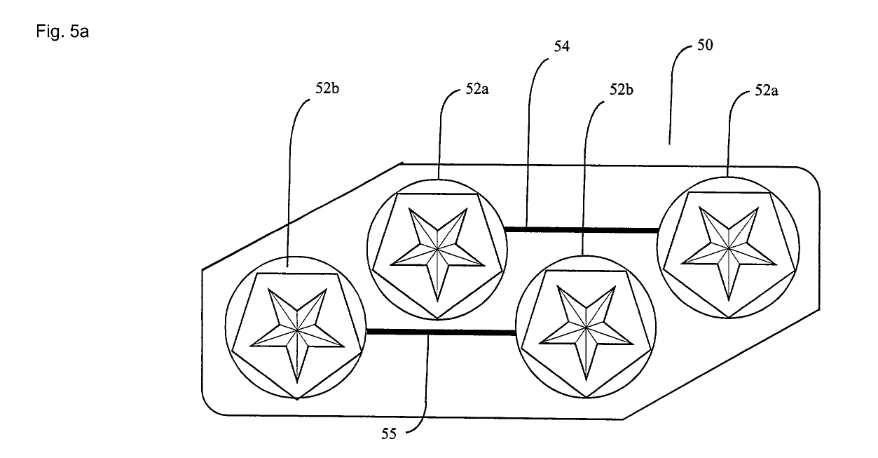

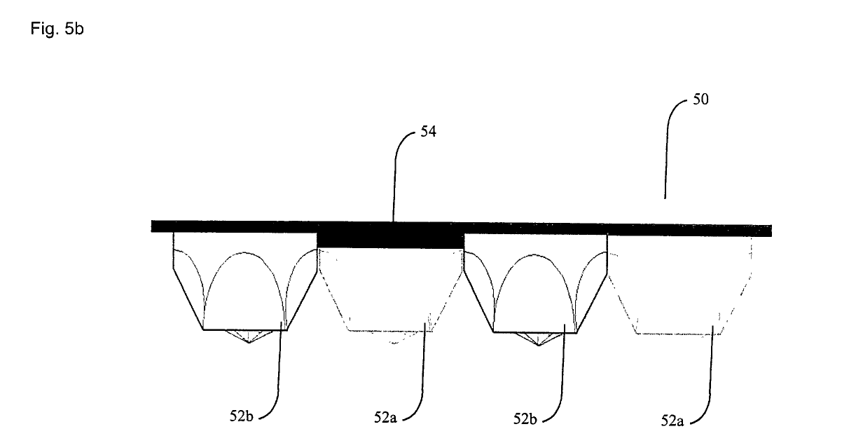

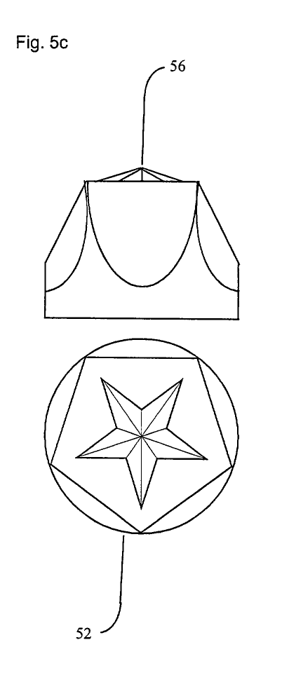

FIG. 5(a) shows a planar view of a truffle mold 50 for making ice cream truffle novelties. In particular, 52(a) and 52(b) are the truffle cavities for receipt of ice cream and aggregate material. Reinforcement struts 54 and 55 are provided to reinforce the mold.

FIG. 5(b) shows a side view of truffle mold 50, showing the truffle cavities 52(a) and 52(b). In particular, cavities 52(a) are shown behind cavities 52(b) by the difference in shading. Reinforcement strut 54 is also visible.

FIG. 5(c) shows the top view 52 and side view 56 of finished truffles, in accordance with the molds shown in FIGS. 5(a) and 5(b). It should be appreciated that by changing the top design, currently shown as a star, additional designs may be employed without deviating from the letter, spirit or claimed scope of the subject invention.

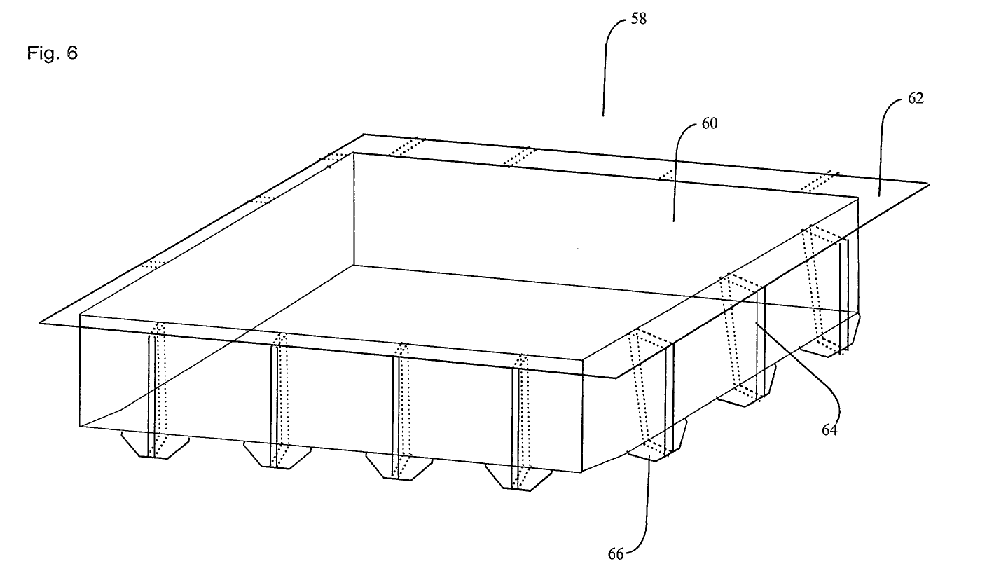

FIG. 6 shows a sheet cake mold 58 for use in making a sheet cake. Cavity 60 is shown for receiving ice cream and aggregate material. Deck 62 provides firmness and structural integrity while also permitting a purchase for demolding. Struts 64 and strut base 66 are also provided for structural integrity.

FIG. 7 shows the critical time and temperature parameters in association with the use of an ice cream pop-styled mold, in this instance employing 2.5 ounces of a 10% vanilla ice cream custard, having 27% overrun (i.e., the amount of air in the ice cream). The blast freezer temperature is maintained at −29.6° F. In this instance, it can be observed that the aggregate is unmolded from the mold after the aggregate in the mold has sat for 52 minutes at the blast freezer temperature of −29.6° F., and the aggregate has reached a temperature of −10° F. At this point, the aggregate is unmolded with minimal change in the integrity of the aggregate. No change in integrity occurs at optimal unmolding of the aggregate when it has reached a temperature of −14° F., which occurs at one hour at the blast freezer temperature of −29.6° F.

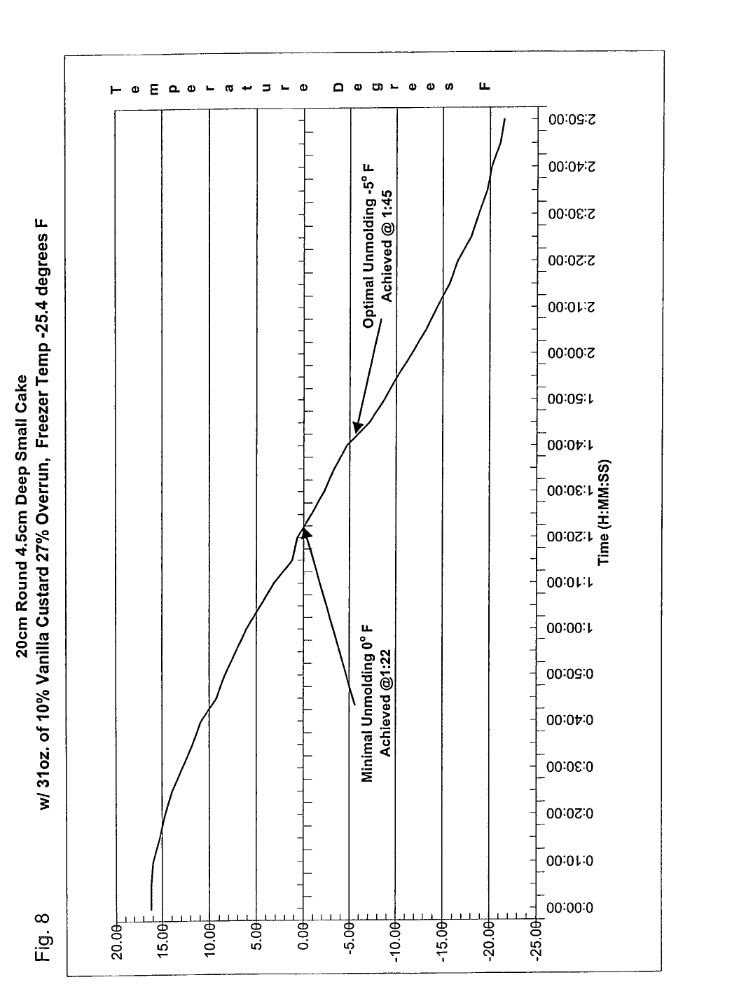

FIG. 8 shows the critical time and temperature parameters in association with the use of a 20 cm round by 4.5 cm deep small cake mold, in this instance employing 31 ounces of a 10% vanilla ice cream custard, having 27% overrun (i.e., the amount of air in the ice cream). The blast freezer temperature is maintained at −25.4° F. In this instance, it can be observed that the aggregate is unmolded from the mold after the aggregate in the mold has sat for 1 hour, 22 minutes at the blast freezer temperature of −29.6° F., and the aggregate has reached a temperature of 0° F. At this point, the aggregate is unmolded with minimal change in the integrity of the aggregate. No change in integrity occurs at optimal unmolding of the aggregate when it has reached a temperature of −5° F., which occurs at one hour and forty five minutes at the blast freezer temperature of −29.6° F.

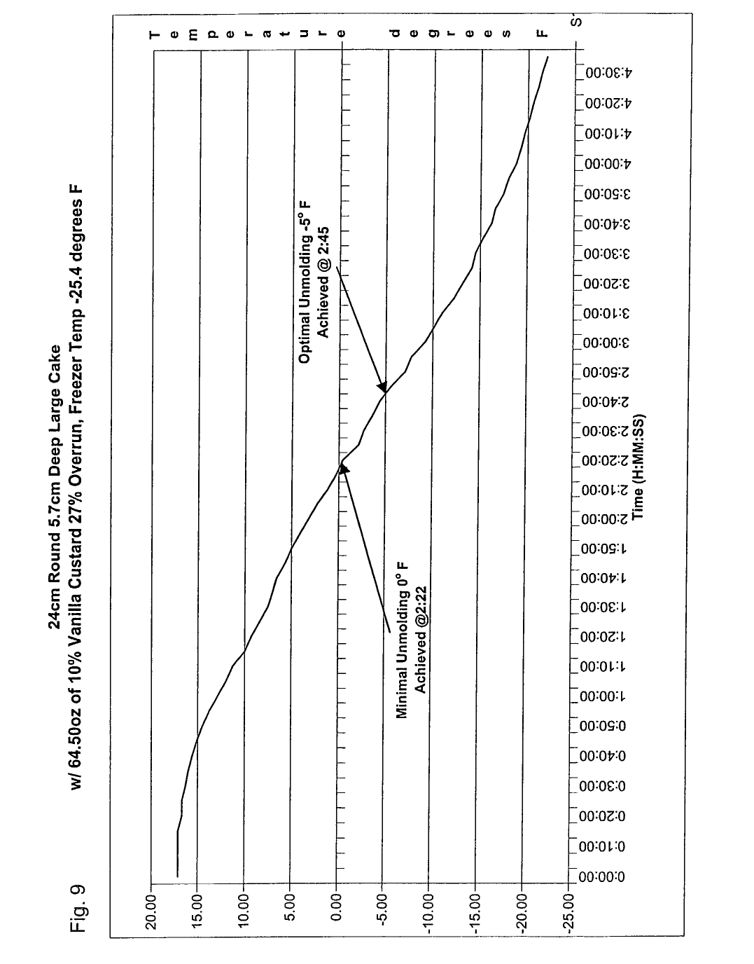

FIG. 9 shows the critical time and temperature parameters in association with the use of a 24 cm round by 5.7 cm deep small cake mold, in this instance employing 64.5 ounces of a 10% vanilla ice cream custard, having 27% overrun (i.e., the amount of air in the ice cream). The blast freezer temperature is maintained at −25.4° F. In this instance, it can be observed that the aggregate is unmolded from the mold after the aggregate in the mold has sat for 2 hours, 22 minutes at the blast freezer temperature of −29.6° F., and the aggregate has reached a temperature of 0° F. At this point, the aggregate is unmolded with minimal change in the integrity of the aggregate. No change in integrity occurs at optimal unmolding of the aggregate when it has reached a temperature of −5° F., which occurs at two hours and forty five minutes at the blast freezer temperature of −29.6° F.

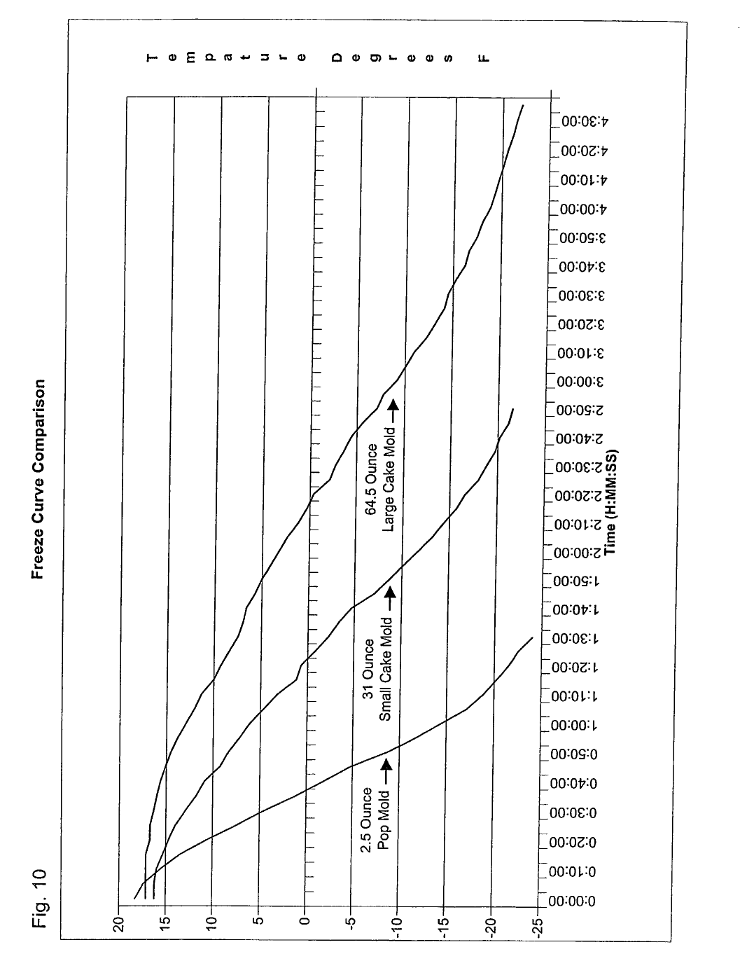

FIG. 10 shows the combination of the three molds shown in each of FIGS. 7, 8 and 9, with the same information provided. This graph shows the correlation between the three.

While there have been shown, described and pointed out fundamental novel features of the invention as applied to preferred embodiments thereof, it will be understood that various omissions and substitutions and changes in the form and details of the device illustrated and in its operation may be made by those skilled in the art without departing from the spirit of the invention. It is the intention, therefore, to be limited only as indicated by the scope of the claims appended hereto.

I claim:

1. A system for the making of ice cream novelties and cakes, comprising:
(a) selecting a mold comprised of a flexible, elastomeric, silicone-based material;
(b) obtaining ice cream in a temperature range between 0° F. to 20° F.;
(c) folding the ice cream into the selected mold to create a molded material;
(d) allowing the molded material to harden at a time and temperature sufficient to permit minimal to optimal hardness for demolding without sacrifice of integrity of the molded material; and
(e) demolding the molded material from the mold.

2. The system of claim 1, wherein the flexible, elastomeric, silicone-based material is comprised of a combination of GE 6035 and GE 6075.

3. The system of claim 2, wherein the combination is 25% and 75% of GE 6035 and GE 6075, respectively.

4. The system of claim 1, further including the steps, between steps (c) and (d), of:
(c1) applying a first material to create an aggregate of material and ice cream as the molded material; and
(c2) increasing the firmness of the molded material by lowering the temperature to between 10° F. and −10° F.

5. The system of claim 4, further comprising the steps, after step (c2), of:
(c3) applying a second material to said molded material.

6. The system of claim 4, wherein the first material is a filling.

7. The system of claim 4, wherein the first material is a layer.

8. The system of claim 5, wherein the second material is a filling.

9. The system of claim 5, wherein the second material is a layer.

10. The system of claim 1, wherein the selected mold is an ice cream pop mold of a size 8 cm by 4.7 cm by 2.5 cm, and the minimal unmolding occurs at −10° F. at 52 minutes and optimal unmolding occurs at −14° F. at one hour.

11. The system of claim 1, wherein the selected mold is a deep small cake mold 20 cm round by 4.5 cm deep, and the minimal unmolding occurs at 0° F. at one hour and twenty-two minutes and optimal unmolding occurs at −5° F. at one hour and forty five minutes.

12. The system of claim 1, wherein the selected mold is a deep large cake mold 24 cm round by 5.7 cm deep, and the minimal unmolding occurs at 0° F. at two hours and twenty two minutes and optimal unmolding occurs at −5° F. at two hours and forty five minutes.

13. The ice cream product achieved by using the system of claim 1.

14. A method for molding ice cream novelties and cakes, comprising:
(a) folding ice cream into a mold comprised of a flexible, elastomeric, silicone-based material at a temperature range between 0° F. to 20° F. to create a molded material;
(b) allowing the molded material to harden at a time and temperature sufficient to permit minimal to optimal hardness for demolding without sacrifice of integrity of the material; and
(e) demolding the molded material from the mold.

15. The method of claim 14, wherein the selected mold is an ice cream pop mold of a size 8 cm by 4.7 cm by 2.5 cm, and the minimal unmolding occurs at −10° F. at 52 minutes and optimal unmolding occurs at −14° F. at one hour.

16. The method of claim 14, wherein the selected mold is a deep small cake mold 20 cm round by 4.5 cm deep, and the minimal unmolding occurs at 0° F. at one hour and twenty-two minutes and optimal unmolding occurs at −5° F. at one hour and forty five minutes.

17. The method of claim 14, wherein the selected mold is a deep large cake mold 24 cm round by 5.7 cm deep, and the minimal unmolding occurs at 0° F. at two hours and twenty two minutes and optimal unmolding occurs at −5° F. at two hours and forty five minutes.

18. The ice cream product achieved by using the method of claim 17.
